(19) United States
(12) Patent Application Publication
(10) Pub. No.: US 2008/0257184 A1
(43) Pub. Date: Oct. 23, 2008

(54) Ductor for a Printing Press

(75) Inventors: Thomas Storte, Bargteheide (DE); Siegfried Bednarczyk, Glinde (DE)

Correspondence Address: BANNER & WITCOFF, LTD., 1100 13th STREET, N.W., SUITE 1200, WASHINGTON, DC, 20005-4051, US

(73) Assignee: ROLF MEYER GMBH, Bargteheide (DE)

(21) Appl. No.: 12/097,464

(22) PCT Filed: Dec. 13, 2006
(86) PCT No.: PCT/EP2006/012006

§ 371 Date: Jun. 13, 2008

(30) Foreign Application Priority Data
Dec. 13, 2005 (DE) 20 2005 019 482.4

(51) Int. Cl. B41F 31/14; B41F 35/00

(52) U.S. Cl. 101/348; 101/425

(57) ABSTRACT

A ductor for a printing press having a rounded ductor profile (3) is distinguished by the fact that the radius of curvature of the ductor profile (3) is greater at the point (10) which corresponds to the ductor angle (α) than at a tangent point (11) which lies 20° further towards the tip and smaller than at a tangent point (12) which lies 15° further towards the flank.

The invention relates to a ductor for a printing press having a rounded ductor profile. The ductor profile is the cross-sectional shape of the edge of the ductor destined to be in contact with a roll. In the case of a known ductor (DE-2110299 A), the ductor profile is designed to be rounded at one side. The portion of the ductor adapted to be positioned against the roll is designed with a cross-section that is curved in a convex manner against the roll in the strip-off region. The ductor gap thus gradually tightens in the inlet and widens smoothly in the outlet. Thus, it is to be achieved that disturbing particles, in particular color dust and lint, are dragged along through the constriction and cannot deposit in front of the ductor in a disturbing manner. This ductor appears to never have been applied in practice. This may relate to the fact that it is possible to prevent disturbing deposits in a simpler manner.

The invention, however, has recognized that another important object may be solved by the rounding of the ductor profile, namely that a quick, constant stripping off by applying the ductor can be attained. This is achieved in that, with a ductor angle of between approx. 20 and 40°, the angle of curvature of the ductor profile increases from the tip to the flank. At the tangent point that corresponds to the ductor angle, the radius of curvature is greater than at the tangent point that corresponds to a ductor angle that is by 20° greater, and smaller than at the tangent point that corresponds to a ductor angle that is by 15° smaller. In a preferred embodiment that is provided for a ductor angle of approx. 30°, the radius of curvature of the ductor profile is greater at the 30° tangent point than at the 50° tangent point and smaller than at the 15° tangent point. Preferably, it is greater than at the 40° tangent point, and/or smaller than at the 20° tangent point. The tangent point to a particular angle means that point of the profile at which a tangent is in contact which includes this angle with the central axis of the profile. The angle is that angle at which the ductor is positioned against the tangent in the tangent point of the roll surface.

The radius of curvature in the 30° tangent point lies expediently between the half and the three-fold strength of the ductor sheet, preferably between the 0.8- and 2-fold, and further preferred between the 1- and 1.5-fold strength. The radiuses of curvature in the 50°, 30°, and 15° tangent point behave preferably like (0.4 to 0.7) to 1 to (1.5 to 4).

The ductor profile according to the invention allows to waive a thin-ground lamella. This means a ductor profile that is formed by a section with a substantially constant, but substantially lower strength than the rest of the ductor knife. It has the disadvantage that it is costly to manufacture and, in some cases of use, influences the elasticity properties of the ductor and the stripping off by applying the ductor in an unfavorable manner. The ductor according to the invention, on the contrary, distinguishes itself advantageously by the fact that the strength of the ductor knife is constantly the same from the bearing point to the ductor profile.

According to a particular feature of the invention, the ductor profile is designed symmetrically at both sides. Thus, the errors that sometimes occur with an asymmetrical ductor profile by wrong insertion of the ductor are avoided. It may also be of interest to turn over a ductor that has already been used at one side and to use it again with the other side.

The shaping of the profile may, for instance, be performed by grinding or by spark erosion.

It has been found that the ductor according to the invention, when used in a chamber ductor device, results in an improved color inclusion in the chamber and in a minor deposition of the color.

In the following, the invention will be explained in more detail with reference to the drawing which illustrates an advantageous embodiment. There show:

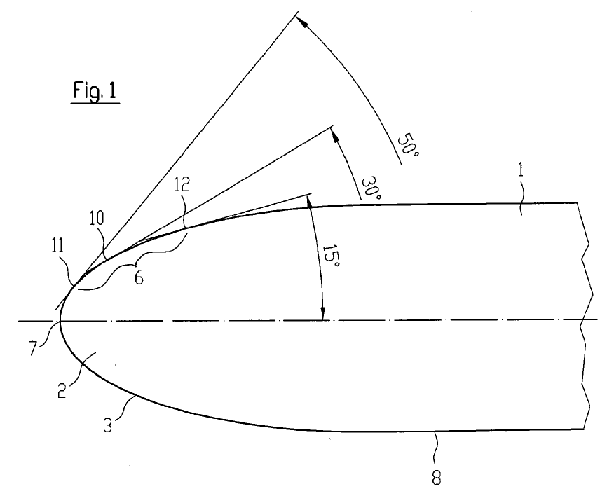

FIG. 1 the ductor profile, and

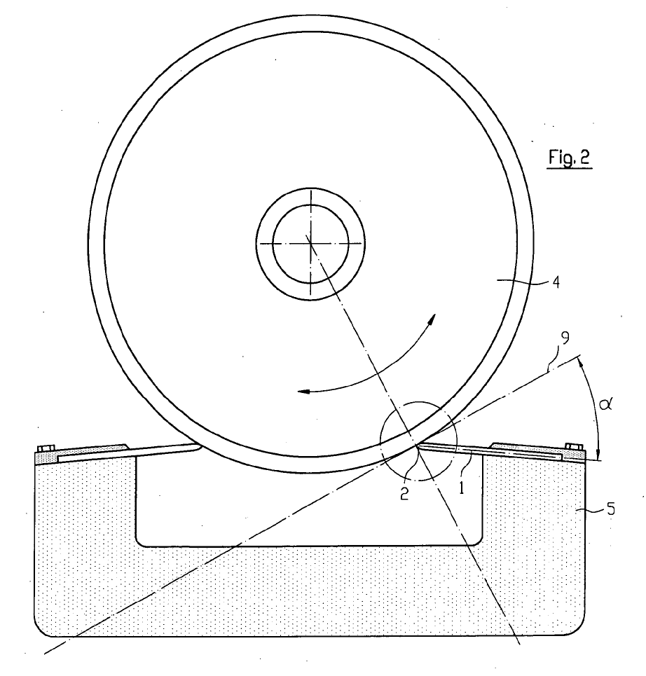

FIG. 2 the use with a ductor chamber.

The ductor 1 that, as a rule, consists of resilient metal and has a strength of, for instance, 0.1 mm, comprises an end portion or edge 2 that is destined to get into contact with the surface of a roll 4. The ductor is, for instance, arranged at a chamber ductor 5 for flexoprinting. The ductor profile 3 is, according to the invention, characterized in that its radius of curvature increases from the tip 7 to the flank 8 in the region 6 in which the contact of the ductor knife with the surface of the roll 4 may occur. The ductor strength is expediently constant for the rest. It ranges in general in the dimension of 0.1 to 0.3 mm.

The usually preferred ductor angle, that is the angle α at which the ductor 1 is positioned with respect to the roll tangent 9 in the tangent point, is frequently chosen in the dimension of 30°. In this case, the ductor profile in new condition is in contact with its point 10 with the roll surface 3. This point is here referred to as 30° tangent point. The radius of curvature of the profile at this point is greater than at any point that is positioned closer to the tip 7 in the region 6. It is in particular greater than at the 50° tangent point 11 and smaller than at the 150 tangent point 12. Preferably, it is greater than at the 40° tangent point (not illustrated), and/or smaller than at the 20° tangent point (not illustrated). The changing of the radius of curvature preferably takes place continuously. This is, however, not necessarily required.

The smaller the ductor angle, the larger the bevel of the ductor knife that is in contact with the roll surface 3 will be formed later after the removal of material from the ductor knife. The larger will, when selecting the ductor profile according to the invention, also be that surface region of the ductor knife that is directly close to the roll surface in the initial condition. The smaller will be the difference between the shape of the ductor profile in new condition and in the later condition. And the smaller will also be the difference in the effect of the ductor. The result of this is a quick stripping off by applying the ductor without substantial modification of the printing quality. Since this is achieved without thin grinding, high stability in the working area is also achieved without the bending through that occurs with a conventional thin-ground lamella.

Due to the symmetrical design of the ductor profile, the alignment of the ductor knife need not be observed when it is inserted. This facilitates assembling and prevents errors by misalignment.

1. A ductor for a printing press having a rounded ductor profile, characterized in that the radius of curvature of the ductor profile is greater at the point which corresponds to the ductor angle (α) than at a tangent point which lies 20° further towards the tip, and smaller than at a tangent point which lies 15° further towards the flank.

2. The ductor according to claim 1, characterized in that the radius of curvature of the ductor profile at the 30° tangent point is greater than at the 50° tangent point, and smaller than at the 15° tangent point.

3. The ductor according to claim 2, characterized in that the radius of curvature at the 30° tangent point is greater than at the 40° tangent point, and/or smaller than at the 20° tangent point.

4. The ductor according to claim 3, wherein the ductor profile is symmetrical at both sides.

5. The ductor according to claim 4, wherein the radius of curvature at the 30° tangent point lies between the half and the three-fold ductor sheet strength.

6. The ductor according to claim 5, wherein the radiuses of curvature at the 50°, 30°, and 15° tangent points behave like (0.4 to 0.7) to 1 to (1.5 to 4).

7. The ductor according to claim 6, wherein its strength is constant for the rest.

8. The ductor according to claim 1, wherein the ductor profile is symmetrical at both sides.

9. The ductor according to claim 1, wherein the radius of curvature at the 30° tangent point lies between the half and the three-fold ductor sheet strength.

10. The ductor according to claim 1, wherein the radiuses of curvature at the 50°, 30°, and 15° tangent points behave like (0.4 to 0.7) to 1 to (1.5 to 4).

11. The ductor according to claim 1, wherein its strength is constant for the rest.
